(19) United States
(12) Patent Application Publication
(10) Pub. No.: US 2009/0160104 A1
(43) Pub. Date: Jun. 25, 2009

(54) MANUFACTURING METHOD OF CERAMIC FIBERS

(75) Inventor: Chen-Liang Li, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: TAIWAN TEXTILE RESEARCH INSTITUTE, Taipei Hsien (TW)

(21) Appl. No.: 11/964,013

(22) Filed: Dec. 25, 2007

(51) Int. Cl. B28B 1/00

(52) U.S. Cl. 264/614

(57) ABSTRACT

A manufacturing method of ceramic fibers is provided. First, a ceramic powder and a solution are mixed into a mixed slurry. The mixed slurry is then spun in water to form a plurality of blank fibers. Next, the blank fibers are sintered to form a plurality of ceramic fibers. In the prior art, ceramic fibers are manufactured by using organic metal salts and toxic solvents as raw materials, which complicates the process and always cause environmental pollution. The manufacturing method of ceramic fibers of the present invention utilizes a ceramic material and a non-toxic solution as the raw materials. The method of the present invention is simple, cost saving, and has no pollution, and is applicable to manufacturing piezoelectric ceramic fibers or other ceramic fibers.

### BACKGROUND OF THE INVENTION

1. Field of the Invention

The present invention generally relates to a manufacturing method of ceramic fibers. More particularly, the present invention relates to a manufacturing method of piezoelectric ceramic fibers.

2. Description of Related Art

The piezoelectric effect is discovered by Pierre Curie and Jacques Curie in 1880. The piezoelectric effect is an expression of the electric dipole moment property of a cell since the crystal lattice is not centrally symmetric, i.e., the cell does not have electric neutrality. When suffering a twisting force, the material with such property will generate electrical polarization and then generate electromotive force (EMF). In detail, the piezoelectric material has the property of reversible transformation between mechanical energy and electrical energy. Therefore, the piezoelectric material is widely applied in motion sensors, actuators, converters, micro-locators, vibration detectors, and sound wave generators, and so on.

However, the conventional piezoelectric material is typically in monocrystalline form or polycrystalline form, and is rigid, heavy and fragile, so the conventional piezoelectric material cannot be easily applied in various applications. If the piezoelectric material is made into fibers, not only the mechanical properties such as thermal properties, chemical properties, and flexibilities of the material can be improved, but also the piezoelectric properties, the sensitivity, and the electromechanical coupling coefficient can be significantly improved due to the increase of the aspect ratio. Therefore, the piezoelectric fiber material is extensively studied and applied in various equipments designed based on the piezoelectric phenomenon. The application of the manufacturing method of ceramic fibers in manufacturing the piezoelectric material is an indispensable technology.

Currently, several manufacturing methods of ceramic fibers have been applied in manufacturing the piezoelectric ceramic fibers. U.S. Pat. No. 3,760,049 set fourth a continuous equipment for preparing ceramic fibers. During the manufacturing process, a suction drying equipment is required to remove the solvent and a pre-sintering step is required to complete the manufacturing of the ceramic fibers. Therefore, the manufacturing process is complicated and the raw materials of organic metal salts are likely to spill over and cause environmental pollution in the course of suction. In the manufacturing method of ceramic fibers of U.S. Pat. No. 4,921,328, an organic metal solution is used as a raw material for manufacturing ceramic fibers. The organic metal solution is always toxic and will cause environmental pollution during removing the solvent.

Furthermore, Germany Patent No. DE-C4332831, i.e. U.S. Pat. No. 5,945,029 set forth a manufacturing method of piezoelectric ceramic fibers. In the method, organic metal salts are made into a sol-gel for manufacturing piezoelectric fibers. However, the manufacturing method has the disadvantages that the process is complicated and the adopted organic metal salts and solvents are always toxic and are likely to pollute the environment. Furthermore, in order to prevent the length of ceramic fibers from being limited by the volume shrinkage occurring in the sintering, the manufacturing method also requires a drying equipment to remove the solvent.

In addition to the above methods, U.S. Pat. No. 6,451,059 further set forth a low-cost viscous suspension spinning process (VSSP), in which man-made fibers and high-content ceramic powder are mixed for manufacturing ceramic fibers. In this method, the fibers are deteriorated by sulfuric acid, and the sulfuric acid may be left in the ceramic fibers, thus influencing the properties of the ceramic fibers. Furthermore, if the acid/alkali substance such as sulfuric acid is desired to be completely removed by sintering, the generated sulfide and chloride will also cause environmental pollution, and further cause corrosion of the furnace.

The above manufacturing methods of the ceramic fibers will cause environmental pollution and has complicated manufacturing processes. Particularly, when the piezoelectric ceramic fibers are manufactured, a lead (Pb) containing substance must be added into the raw material, thus aggravating the problem of the environmental pollution. However, Pb is irreplaceable in the piezoelectric material, and cannot be completely replaced by other element. Therefore, it is the problem in need of solution that the high-quality ceramic fibers, especially piezoelectric ceramic fibers are fabricated while reducing the equipment costs, and avoiding causing environmental pollution.

### SUMMARY OF THE INVENTION

Accordingly, the present invention is directed to a manufacturing method of ceramic fibers to solve the problems of environmental pollution and complicated operation and equipments in conventional manufacturing method of ceramic fibers.

The present invention is directed to a manufacturing method of ceramic fibers. First, a ceramic powder and a solution are mixed to get a mixed slurry, wherein the solution comprises polyvinyl acetate. Next, the mixed slurry is spun in water to form a plurality of blank fibers. And then, the blank fibers are sintered to form a plurality of ceramic fibers.

In an embodiment of the present invention, the content of the solution is 20 wt % to 70 wt %, and the ratio of the solution to the ceramic powder is 20 wt % to 50 wt %.

In an embodiment of the present invention, the mixed slurry further includes thermoplastic polyurethane (TPU) pellet, polyethylene terephthalate (PET), cellulose, polyamide(polyamide), chitin, and combinations thereof.

In an embodiment of the present invention, the ceramic powder is a piezoelectric ceramic powder. The piezoelectric ceramic powder may be expressed by ABO₃, where A is Pb, Ba, La, Sr, K, or Li, and so on, and B is Ti, Zr, Mn, Co, Nb, Fe, Zn, Mg, Y, Sn, Ni, or W, and so on.

In another embodiment of the present invention, the ceramic powder includes carbides, metal salts, or metal oxides.

In an embodiment of the present invention, the step of spinning in water is described as follows. First, a spinning device having at least one hole is provided. Next, the mixed slurry is filled into the spinning device. And then, the mixed slurry is extruded by pressure to extrude the mixed slurry into a water bath through the at least one hole, so as to form the blank fibers.

In an embodiment of the present invention, a diameter of the at least one hole is between 1 μm and 1000 μm.

In an embodiment of the present invention, the pressure for extruding the mixed slurry is between 1 kg/cm² and 20 kg/cm².

In an embodiment of the present invention, a temperature of the water bath is between 4° C. and 50° C.

In an embodiment of the present invention, a diameter of the blank fibers is between 1 μm and 1000 μm.

In an embodiment of the present invention, after the process of spinning in water, a drying step is further performed.

In an embodiment of the present invention, a temperature of the drying step is between 4° C. and 80° C.

In an embodiment of the present invention, the drying step includes air drying or heating drying.

In an embodiment of the present invention, after forming the blank fibers, a cutting step is further performed so as to make the blank fibers have a specific length.

In an embodiment of the present invention, a temperature of the sintering step is between 600° C. and 1400° C.

In an embodiment of the present invention, after the sintering step, a cutting step is further performed so as to make the blank fibers have a specific length.

In an embodiment of the present invention, a duration of the sintering step is between 10 min and 10 hr.

In an embodiment of the present invention, a diameter of the ceramic fibers is between 0.5 μm and 900 μm.

Since the present invention utilizes non-toxic ceramic powders and solutions for manufacturing the material of ceramic fibers as raw materials, the problem of environmental pollution will not occur. Furthermore, the spinning step of the present invention is required to be performed in pure water, thus reducing the manufacturing cost and simplifying the manufacturing process.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic flow chart of a manufacturing method of ceramic fibers according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### The First Embodiment

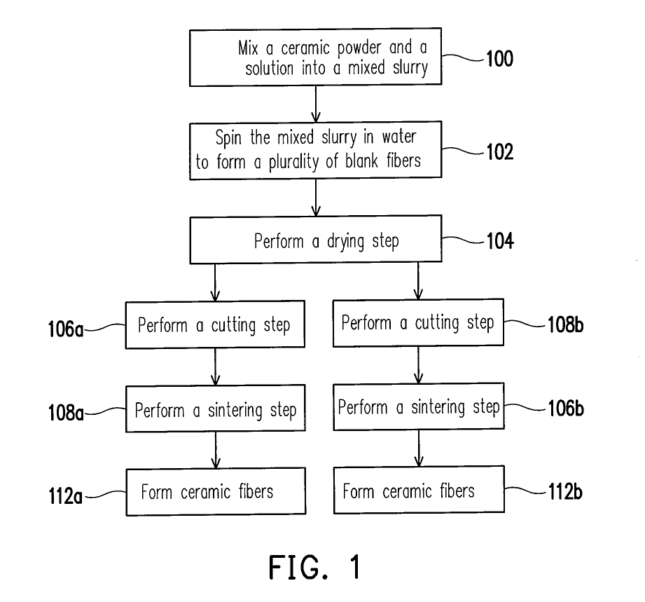

FIG. 1 is a schematic flow chart of a manufacturing method of ceramic fibers according to an embodiment of the present invention. First, referring to Step 100 in FIG. 1, a ceramic powder and a solution are mixed into a mixed slurry, wherein the solution comprises polyvinyl acetate. The content of the solution is, for example, 20 wt % to 70 wt %, and the ratio of the solution to the ceramic powder is, for example, 20 wt % to 50 wt %.

In an embodiment, the ceramic powder is a piezoelectric ceramic powder. The piezoelectric ceramic powder may be expressed by ABO₃. A is Pb, Ba, La, Sr, K, or Li, and so on, and B is Ti, Zr, Mn, Co, Nb, Fe, Zn, Mg, Y, Sn, Ni, or W, and so on. The piezoelectric ceramic powder may be used as a raw material for ceramic fibers, so as to manufacture a piezoelectric fiber material, i.e., piezoelectric ceramic fibers. In addition to excellent piezoelectric properties, the piezoelectric ceramic fibers have good mechanical properties of ceramic fibers, thus being widely applied in manufacturing piezoelectric equipments.

Furthermore, in addition to the piezoelectric ceramic powder, other ceramic powders may also be used as a raw material, so as to be applied in different fields. In other embodiments, the ceramic powder includes carbides, metal salts, or metal oxides.

In an embodiment, the mixed slurry further includes TPU, PET, cellulose, polyamide, chitin, and combinations thereof. As the mixed slurry used in the present invention is composed of non-toxic solutions and ceramic powders, no environmental pollution will be caused.

Next, in Step 102 in FIG. 1, the mixed slurry is spun in water to form a plurality of blank fibers. In an embodiment, in the spinning process, a spinning device having at least one hole is first provided. The mixed slurry is filled into the spinning device. Next, the mixed slurry is extruded by pressure, such that the mixed slurry is extruded into a water bath through the hole, thereby forming the blank fibers. In the manufacturing method of ceramic fibers of the present invention, after being extruded through a mold, the mixed slurry may form the blank fibers by merely reacting with water without using other acid/alkali solution or other processes. Therefore, the properties of the fiber product will not be affected by the residual acid/alkali substance, the complicated steps of removing the acid/alkali substance are not required, and the environmental pollution is prevented, thus further reducing the manufacturing cost.

In the embodiments of the present invention, the diameter of the hole of the spinning device is between 1 μm and 1000 μm. The pressure for extruding the mixed slurry is, for example, between 1 kg/cm² and 20 kg/cm². Furthermore, the temperature of water bath is, for example, between 4° C. and 50° C. The diameter of the blank fibers manufactured through the above steps is, for example, between 1 μm and 1000 μm.

Thereafter, in Step 104 in FIG. 1, after the process of spinning in water, a drying step is further performed. The temperature of the drying step is preferably 4° C. and 80° C., and the drying step is performed by, for example, air drying or heating drying.

The present invention has the advantages that the blank fibers can be dried by air drying or heating drying without using an additional suction equipment to remove the solution in the mixed slurry. Therefore, relevant vacuum drying or evacuating drying equipments are not required, thus reducing the equipment cost, and avoiding causing environmental pollution in the course of removing the solution.

Then, in Step 106a in FIG. 1, after the blank fibers are dried, a cutting step is further performed so as to make the blank fibers have a specific length. In this manner, ceramic fibers with desired length may be manufactured according to specific requirements.

Next, in Step 108a in FIG. 1, the filamentous structures (blank fibers) after being dried and cut into desired length are directly sintered. In an embodiment, the temperature of the sintering step is between 600° C. and 1400° C., and the duration of the sintering step is, for example, between 10 min and 10 hr.

Thereafter, in Step 112a in FIG. 1, the manufacturing of the ceramic fibers is completed after the sintering step, and the diameter of the fabricated ceramic fibers is, for example, between 0.5 μm and 900 μm.

### The Second Embodiment

The manufacturing method of ceramic fibers of this embodiment is substantially the same as that of the first embodiment, and the steps following Step 104 are different.

Referring to Step 104 to Step 112b in FIG. 1, in this embodiment, after the blank fibers are dried in Step 104, the blank fibers are directly filled into a high temperature furnace to be sintered, i.e., Step 108b is performed. After the sintering step in Step 108b, a cutting step in Step 106b is performed to form ceramic fibers with desired length. Next, as shown in Step 112b, the ceramic fibers with desired length are obtained. In this embodiment, the preparing method of the mixed slurry, raw materials, forming method of the blank fibers, the conditions of the drying step, the sintering step, and the cutting step are substantially the same as those of the first embodiment and will not be repeated herein.

In view of the above, the manufacturing method of ceramic fibers of the present invention at least has the following advantages.

(1) The mixed slurry used in the present invention is non-toxic, so will not cause environmental pollution problem.

(2) The manufacturing method of ceramic fibers of the present invention does not use pollutant chemicals, such as sulfide and chloride, so no relevant environmental problem is caused and the furnace and equipment will not be corroded.

(3) The ceramic fibers manufactured according to the present invention does not have the problem that the properties of the ceramic fiber product may be deteriorated by the residual acid, alkali, sulfides, or chlorides.

(4) The manufacturing method of ceramic fibers of the present invention can achieve the efficacy of reducing the manufacturing cost and simplifying the manufacturing process.

(5) When the present invention is applied in manufacturing piezoelectric ceramic fibers, the properties and size of the piezoelectric ceramic fibers are easily controlled, thus further improving the quality of the piezoelectric ceramic fibers.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A manufacturing method of ceramic fibers, comprising:
mixing a ceramic powder and a solution into a mixed slurry, wherein the solution comprises polyvinyl acetate;
spinning the mixed slurry in water to form a plurality of blank fibers; and
sintering the blank fibers to form a plurality of ceramic fibers.

2. The manufacturing method of ceramic fibers according to claim 1, wherein a content of the solution in the mixed slurry is 20 wt % to 70 wt %, and a ratio of the solution to the ceramic powder is 20 wt % to 50 wt %.

3. The manufacturing method of ceramic fibers according to claim 1, wherein the ceramic powder is a piezoelectric ceramic powder.

4. The manufacturing method of ceramic fibers according to claim 3, wherein the piezoelectric ceramic powder is expressed by ABO₃, wherein A is Pb, Ba, La, Sr, K, or Li, and B is Ti, Zr, Mn, Co, Nb, Fe, Zn, Mg, Y, Sn, Ni, or W.

5. The manufacturing method of ceramic fibers according to claim 1, wherein the ceramic powder comprises carbides, metal salts, or metal oxides.

6. The manufacturing method of ceramic fibers according to claim 1, wherein the process of spinning in water comprising:
providing a spinning device having at least one hole;
filling the mixed slurry into the spinning device; and
extruding the mixed slurry by pressure to extrude the mixed slurry into a water bath through the at least one hole, so as to form the blank fibers.

7. The manufacturing method of ceramic fibers according to claim 6, wherein a diameter of the at least one hole is between 1 μm and 1000 μm.

8. The manufacturing method of ceramic fibers according to claim 6, wherein the pressure for extruding the mixed slurry is between 1 kg/cm² and 20 kg/cm².

9. The manufacturing method of ceramic fibers according to claim 6, wherein a temperature of the water bath is between 4° C. and 50° C.

10. The manufacturing method of ceramic fibers according to claim 1, wherein a diameter of the blank fibers is between 1 μm and 1000 μm.

11. The manufacturing method of ceramic fibers according to claim 1, after the process of spinning in water, further comprising a drying step.

12. The manufacturing method of ceramic fibers according to claim 11, wherein a temperature of the drying step is between 4° C. and 80° C.

13. The manufacturing method of ceramic fibers according to claim 11, wherein the drying step comprises air drying or heat drying.

14. The manufacturing method of ceramic fibers according to claim 1, after forming the blank fibers, further comprising a cutting step, so as to make the blank fibers have a specific length.

15. The manufacturing method of ceramic fibers according to claim 1, wherein a temperature of the sintering step is between 600° C. and 1400° C.

16. The manufacturing method of ceramic fibers according to claim 1, after the sintering step, further comprising a cutting step, so as to make the blank fibers have a specific length.

17. The manufacturing method of ceramic fibers according to claim 1, wherein a duration of the sintering step is between 10 min and 10 hr.

18. The manufacturing method of ceramic fibers according to claim 1, wherein a diameter of the ceramic fibers is between 0.5 μm and 900 μm.

19. The manufacturing method of ceramic fibers according to claim 1, wherein the mixed slurry further comprises thermoplastic polyurethane (TPU) pellet, polyethylene terephthalate (PET), cellulose, polyamide, chitin, and combinations thereof.
